(19) United States
(12) Patent Application Publication
(10) Pub. No.: US 2025/0060739 A1
(43) Pub. Date: Feb. 20, 2025

(54) Operating Method and Control System for a Technical Installation

(71) Applicant: Siemens Aktiengesellschaft, Muenchen (DE)

(72) Inventor: Benjamin LUTZ, Pfinztal (DE)

(21) Appl. No.: 18/802,078

(22) Filed: Aug. 13, 2024

(30) Foreign Application Priority Data
Aug. 15, 2023 (EP) 23191437

(51) Int. Cl. G05B 23/02

(52) U.S. Cl. CPC G05B 23/0272

(57) ABSTRACT

Method and control system for a technical installation, in particular a manufacturing or processing installation, includes at least one operator station server and at least one operator station client connected to the operator station server, wherein the operator station server transmits visualization information to the operator station client and the operator station client generates, via the visualization information, a graphical presentation for an operator of the technical installation of a temporal progression of a measured variable of the control system assigned to a technical object of the technical installation within a specific, past time period, where the control system is configured to visually indicate to the operator on the operator station client operating actions that have been implemented by the operator or another operator within the specified, past time period.

### BACKGROUND OF THE INVENTION

### 1. Field of the Invention

The invention relates to a control system for a technical installation, in particular a manufacturing or processing installation, and relates to a method for operating the control system for the technical installation.

### 2. Description of the Related Art

For the operation and monitoring of process engineering systems, symbolic installation images are created that represent the process engineering relationships (in particular between the process objects) in an abstract manner. Installation images are made up of static symbols (for example, lines and/or rectangles), dynamic symbols (for example, lines with color changes depending on process values, rectangles with fill levels), block symbols (for dynamic visualization of process engineering process objects), complex controls (for example, trend displays and/or message sequence displays) and containers to visualize content from independent and autonomous sources (for example webcams, installation images of modular installation parts (package units). In addition, the installation images can comprise applications such as controller optimizers or KPI calculators.

Operators use the installation images and the symbols they contain to perform their operating interventions or process-controlling actions, which are recorded and archived by the control system. These records can then be used for an audit trail to investigate and also trace the actual or also attempted actions of operators during a specific time period. In the event of damage, this allows the chronological sequence of intentional, negligent and incorrect actions to be traced.

It is known that the actions of operators are stored alongside the actual process data in a process data archive as “operating messages” (technically as stateless alarms), which can be read out again if required. The recorded operating messages, which can also be used by the operators themselves in order to better coordinate the operation of the process engineering installation, make it more efficient and minimize errors.

Operating messages are generated automatically at runtime, for example, for the following operator actions (this also includes “negative” operating messages if an input by the operator could not be executed, such as setting a control value):
TagSet (set control value)
TagSetFailed (setting control value failed)
AlarmAckBanner (acknowledge alarm in the alarm banner)
AlarmAckBannerFailed (for alarm acknowledgement in the alarm banner)
AlarmAckPlantDisplay (acknowledge alarm of all alarming process objects in the installation image)
AlarmAckPlantDisplayFailed (alarm acknowledgement of all alarming process objects in the installation image failed)
AlarmAckSequenceDisplay (acknowledge alarm in the message sequence display)
AlarmAckSequenceDisplayFailed (alarm acknowledgement of all alarming process objects in the installation image failed)
AlarmShelve (suppress alarm (shelve) in the message sequence display)
AlarmShelveFailed (suppress alarm (shelve) in the message sequence display failed)
AlarmUnshelve (no longer suppress alarm (unshelve) in the message sequence display)
AlarmUnshelveFailed (alarm no longer suppress (unshelve) in the message sequence display failed); etc.

Each operating message usually has a specific text with meta information that includes, for example, the following information:
What was done?—for example, “Control value increased from 5.0 to 5.5”
Who did it?—for example, “Operator Z4”
When was it done?—for example, on Operator Station Client Y and via Operator Station Server 3

Typically, operator messages are “trimmed” to the audit trail and can usually only be viewed via “message sequence displays”—the effect of the process-controlling action on the process engineering process, or the correlation between the process-controlling action and the process engineering process, can only be determined with a great deal of effort.

EP 3 876 046 A1 discloses a control system for a technical installation that enables an operator to adapt the presentation of visualization information by an operator station client to a runtime of the technical installation.

### SUMMARY OF THE INVENTION

It is an object of the invention to provide a control system for a technical installation that increases the efficiency and flexibility of operation and monitoring of the technical installation.

This and other objects and advantages are achieved in accordance with the invention by a method and control system for a technical installation, in particular a manufacturing or processing installation, which comprises at least one operator station server and at least one operator station client connected to the operator station server, where the operator station server is configured to transmit visualization information to the operator station client, and where the operator station client is configured to, via the visualization information, generate a graphical presentation for an operator of the technical installation of a temporal progression of a measured variable of the control system assigned to a technical object of the technical installation within a specific, past time period.

The control system in accordance with the invention is configured to visually indicate to the operator on the operator station client operating actions that have been performed or implemented by the operator or another operator within the specified, past time period.

The technical installation can be an installation from the processing industry such as a chemical, pharmaceutical, petrochemical or an installation from the food and beverage industry. This also includes any installations from the production industry, plants in which, for example, cars or goods of all kinds are produced. Technical installations that are suitable for performing the method in accordance with the invention can also come from the field of energy generation. Wind turbines, solar installations or power stations for generating energy are also covered by the term “technical installation”.

In the present context, a control system is understood to be a computerized, technical system that includes functionalities for displaying, operating and controlling the process engineering installation. The control system can also include sensors for determining measured values and various actuators. The control system can also include so-called processing- or manufacturing-related components that are used to control the actuators or sensors. In addition, the control system can inter alia have ways to visualize the process engineering installation and for engineering. The control system can optionally also include further computing units for more complex controls and systems for data storage and processing.

An “operator station server” is understood here to be a server including a processor and memory, where the server centrally collects data from an operating and monitoring system and, as a rule, alarm and measured value archives of a process control system of a technical installation and makes the data available to users. The operator station server generally establishes a communication connection to the automation systems of the technical installation and forwards data from the technical installation to so-called operator station clients, which are used to operate and monitor the operation of the individual functional elements of the technical installation. The operator station server can have client functions in order to access the data (archives, messages, tags, variables) of other operator station servers.

This allows images of an operation of the technical installation on the operator station server to be combined with variables from other operator station servers (server-server communication). The Operator Station Server can be, but is not limited to, a SIMATIC PCS 7 Industrial Workstation Server from SIEMENS.

An operator is a human operator of the technical system. The operator interacts with the technical system or its control system via special user interfaces and controls special technical functions of the system. For this purpose, the operator can use the operating and monitoring system of the control system with the operator station server and the operator station client.

The control system in accordance with the invention visually indicates to the operator if an operating action is to be brought into a temporal relationship with the displayed temporal progression of the measured variable assigned to a technical object, such as a pump, a motor or a furnace, such as a temperature, a pressure or a speed. This operating action may have been performed by the operator themselves or by another operator or multiple operators. If, for example, the temporal progression relates to a time period from 1 o'clock to 3 o'clock and one or more operating actions were performed during this time period, the control system visually displays this to the operator. This allows the operator to recognize immediately and without time-consuming searching in the control system archives that one or more of these operating actions may have had an influence on the temporal progression. This makes it easier for the operator to operate and monitor the technical installation efficiently.

The control system can automatically visually present the information. For this purpose, it can, for example, automatically search the relevant time period of the displayed measured variable in an archive of the control system for possible operating actions that have occurred and present them visually.

Preferably, the control system is configured to visually present the indication of the operating actions on the operator station client in response to a request from the operator. This allows the operator to be presented with the information precisely when it is required. In response to the request from the operator, the control system can provide a visually displayed selection field via the operator station client. This is preferably located at a short visual distance from the temporal progression of the measured variable assigned to the technical object of the technical installation, so that the operator can find the selection field intuitively and efficiently.

In the context of an advantageous embodiment of the invention, the control system is configured to draw the attention of the operator to the operating actions by marking the points in time at which one of the operating actions was performed respectively in the temporal progression of the measured variable of the control system assigned to the technical object of the technical installation. The operator thus receives an indication of an existing operating action directly in the diagram with the temporal progression and can immediately and intuitively identify any connection between the temporal progression and the operating action. This allows the operator directly and efficiently in terms of time and cause to localize any jumps or changes in the gradient of the temporal progression downwards or upwards caused by the operating action.

The marking can preferably take the form of a vertical line, which is displayed in the temporal progression and can facilitate the temporal categorization of the operating action. It is particularly preferred that the vertical line has a coloring that differs from a coloring of the temporal progression of the measured variable of the control system assigned to the technical object of the technical installation. This allows the operator to recognize intuitively and efficiently that it is a marking indicating an operating action. The coloring can be a red coloring, where the red color can direct the attention of the operator specifically to the marking.

In the context of a further preferred embodiment of the invention, the control system is configured to provide the visual presentation of the indication of the operating actions in the form of a message sequence display, where the message sequence display comprises operating messages that each relate to an operating action. The operating messages can each include at least the operating action performed, a point in time of the operating action and the identity of the operator who performed the operating action. This provides the operator with further detailed information about the operating action.

The visual presentation of the message sequence display can occur as an alternative or in addition to the marking of the operating action point in time in the temporal progression. The control system can also be configured to visually present the corresponding message sequence display with the relevant operating action when the operator selects the marking in the temporal progression.

The visual presentation of the indication of the operating actions can refer to any operating actions. These do not have to be directly related to the technical object. If, for example, the measured variable pressure is assigned to a reactor as a technical object, then the operating action “Open valve”, which refers to a valve as another technical object, can also be relevant for the reactor if it is actively connected to the valve. This operating action can therefore also be of interest to the operator.

However, the control system can also be configured to, possibly at the discretion of the operator, only visually present the information relating to the technical object to which the measured variable, to which the graphically displayed temporal progression relates, is assigned. If, for example, the measured variable temperature is assigned to a furnace as a technical object, then the control system would only display an operating action that relates to the furnace (“for example exhaust air volume increased”).

Preferably, the control system is configured to perform the graphical presentation of the temporal progression of the measured variable assigned to the technical object of the technical installation based on a selection of an operating message in a message sequence display by the operator, where an operating action of the operating message relates to the technical object assigned to the temporal progression. In other words, the operator can allow the temporal progression associated with the technical object relating to the operating action or operating message (with the operating action marked therein) to be displayed directly from the message sequence display by selecting an operating message.

The objects and advantages are also achieved in accordance with the invention by a method for operating a control system for a technical installation, in particular a manufacturing installation or processing installation, comprising at least one operator station server and at least one operator station client connected to the operator station server. The method comprises:
a) transmitting visualization information by the operator station server to the operator station client,
b) generating a graphical presentation of a temporal progression of a measured variable of the control system assigned to a technical object of the technical installation within a specific, past time period for an operator of the technical installation via the visualization information and by the operator station client, and
c) visually indicating to the operator of operating actions by the operator station client, where the operating actions have been performed/implemented by the operator or another operator within the specified, past time period.

Preferably, the operator station client performs the visual presentation of the indication of the operating actions in response to a request from the operator, where a selection field that is presented visually by the operator station client is preferably provided in response to the request from the operator, most preferably at a small visual distance from the temporal progression of the measured variable assigned to the technical object of the technical installation.

Particularly preferably, the operator station client draws the attention of the operator to the operating actions by marking the points in time at which one of the operating actions was performed respectively in the temporal progression of the measured variable of the control system assigned to the technical object of the technical installation.

In the context of an advantageous embodiment of the invention, the operator station client provides the visual presentation of the indication of the operating actions in the form of a message sequence display, where the message sequence display comprises operating messages which each relate to an operating action.

Preferably, the operator station client can perform the graphical presentation of the temporal progression of the measured variable assigned to the technical object of the technical installation based on a selection of an operating message in a message sequence display by the operator, where an operating action of the operating message relates to the technical object assigned to the temporal progression.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above described characteristics, features and advantages of this invention and the manner in which these are realized are more clearly and more precisely understandable in conjunction with the following description of the exemplary embodiments that are explained in detail in connection with the drawings, in which:

FIG. 1 shows a visual presentation of a temporal progression of a measured variable assigned to a technical object of a technical installation by an operator station client;

FIG. 2 shows the visual presentation of the temporal progression from FIG. 1 together with a visual presentation of a message sequence display by an operator station client according to a first aspect;

FIG. 3 shows the visual presentation of the temporal progression from FIG. 1 together with a visual presentation of a message sequence display by an operator station client according to a second aspect;

FIG. 4 shows a control system according to the invention in a schematic representation; and

FIG. 5 is a flowchart of the method in accordance with the invention.

### DETAILED DESCRIPTION OF THE EXEMPLARY EMBODIMENTS

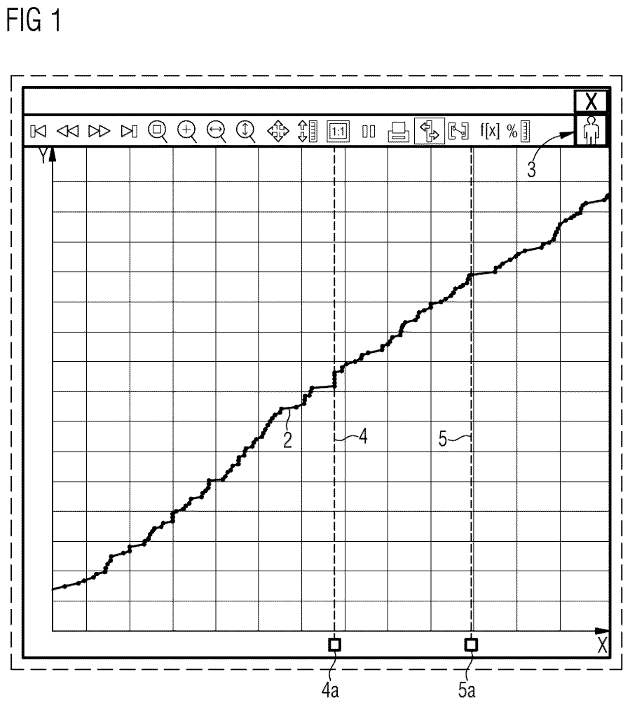

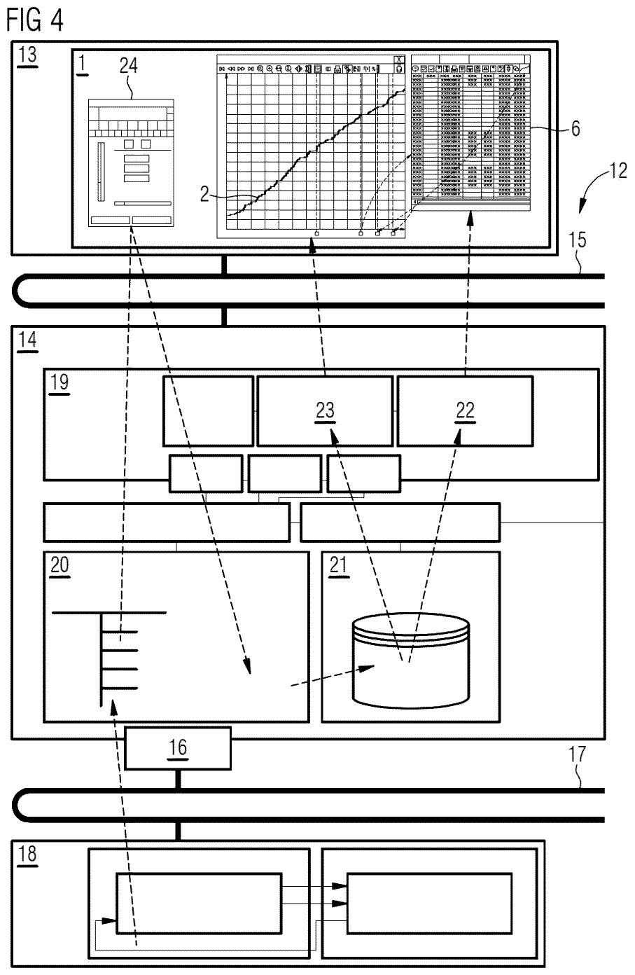

FIG. 1 shows a graphical representation 1 of an operator station client of a control system for a technical installation. For the technical details of the structure of the control system, reference is made to the description in FIG. 4.

The graphical representation 1 comprises a temporal progression 2 of a measured variable assigned to a technical object of the technical installation. The horizontally arranged X-axis represents a point in time within a specific time period, while the vertically arranged Y-axis represents a value.

A selection field 3, symbolized by a person, is arranged in the upper right-hand area of the graphical representation 1. When the operator actuates the selection field 3 by a mouse click, markings are shown on the graphic representation 1. FIG. 1 shows a first marking 4 and a second marking 5 in the form of vertically arranged lines with red coloring. The first marking 4 indicates that an operating action was performed/implemented within the control system at a first point in time 4a. This operating action can refer directly to the technical object on which the temporal progression 2 shown in FIG. 1 is based, but it does not have to. Accordingly, the second marking 5 indicates that a further operating action was performed within the control system at a second point in time 5a. The vertical line markings 4, 5 allow the operator to immediately recognize when operating actions were performed and what influence these had on the temporal progression 2. At both points in time 4a, 5a, it can be seen in FIG. 1 that the temporal progression 2 makes a small jump upwards.

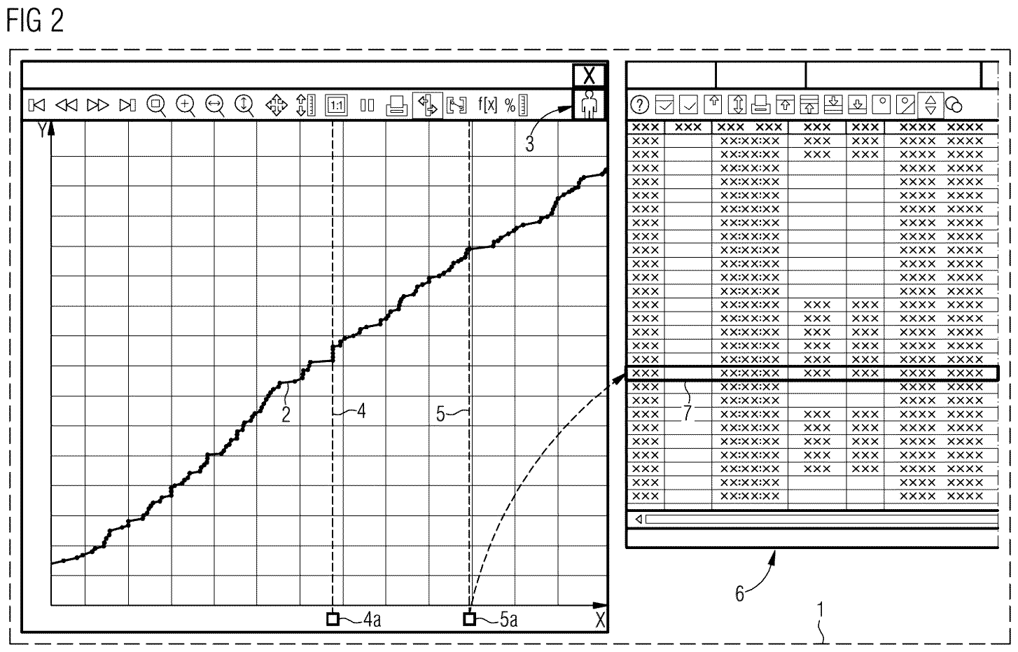

When the operator selects the second marking line 5 (by mouse click or with a finger in the case of a touch-sensitive screen), a message sequence display 6 is automatically shown visually by the operator station client in the graphical representation 1, which can be seen in FIG. 2. The message sequence display 6 comprises a multiplicity of operating messages arranged one below the other, for example, according to a point in time of origin. The operating messages include inter alia information about the operating action performed, the point in time of the operating action and an identity of the operator who performed the operating action.

When the second marking line 5 is selected, a corresponding section of the message sequence display 6 is selected, which includes the operating message 7 associated with the second operating action. This provides the operator with further specific information about the operating action in order to be able to perform a more detailed evaluation.

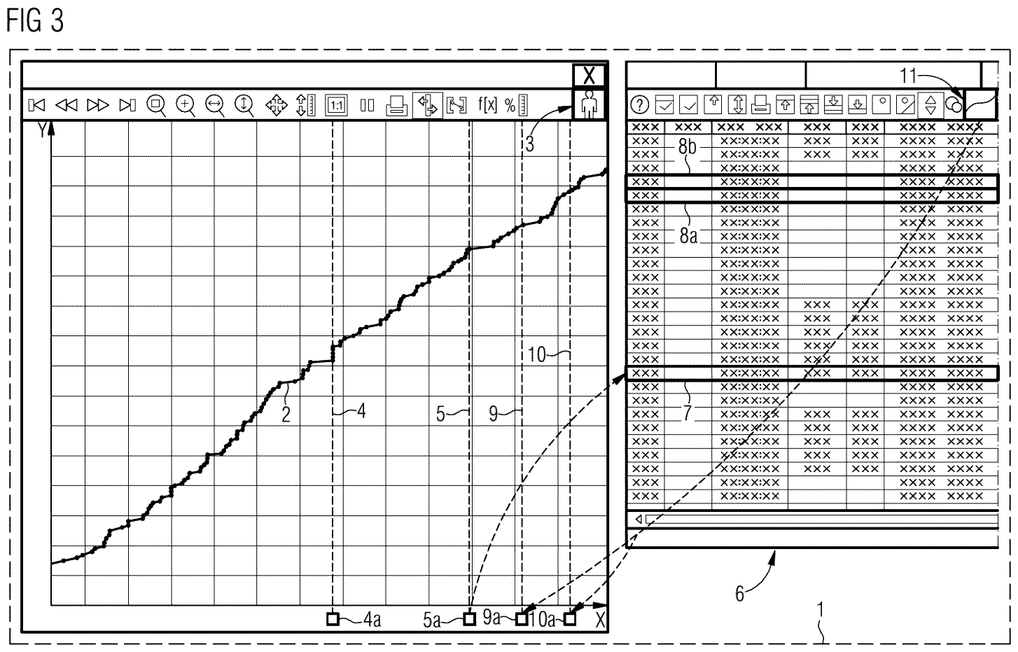

The temporal progression 2 trend curve can be influenced not only by operating actions that affect the underlying technical object, but also by operating actions that are performed on other technical objects. In the presently described exemplary embodiment, the operating actions can relate to any technical objects. In order to associate these operating actions with the temporal progression 2, the operator can perform the step explained in FIG. 3. Firstly, the operator selects any two operating messages 8a, 8b in the message sequence display 6 and transfers them (for example, by “drag & drop” or by selecting a corresponding field 11) to the temporal progression 2.

Two additional markings 9, 10 in the form of red vertical lines are now shown in the temporal progression 2 at two further points in time 9a, 10a. The operator can now check whether the markings on other technical objects had an influence on the temporal progression 2 (and thus, for example, on a process engineering process).

FIG. 4 schematically shows a control system 12 for operating and monitoring a technical installation designed as a processing installation. The control system 12 comprises an operator station client 13 and an operator station server 14. The operator station server 14 and the operator station client 13 are operative coupled or connected to each other via a terminal bus 15 and optionally to other components of the control system 12 not shown, such as an archive server.

A user or operator can access the operator station server 14 for the purpose of operating and monitoring via the operator station client 13 via the terminal bus 15. The terminal bus 15 can, without being limited to this, be formed as an Industrial Ethernet, for example.

The operator station server 14 has a device interface 16 that is connected to an installation bus 17. The operator station server 14 can communicate with an automation device 18 and with other optional components of the technical installation, such as peripheral devices, via this device interface 16. The installation bus 17 can, without being limited to this, be formed as an Industrial Ethernet, for example.

A visualization service 19, an installation image 20 (for example a process image 20) and a local archive memory 21 are implemented on the operator station server 14 (inter alia). The visualization service 19 integrated in the operator station server 14 initiates a transmission of visualization information to the operator station client 13. The operator station client 13 is configured to display a visualization, i.e., a graphical presentation, in particular of installation images, for operating and monitoring the processing installation.

A snapshot of the (signal) states of devices and/or applications connected to the operator station server 14 is stored in the installation image 20 of the operator station server 14. A messaging service 22 can read messages, such as operating messages, from the installation image 20 and the archive memory 21 and, for example, generate a graphical aggregation of the operating messages in the message sequence display 6, which the operator station client 13 can display. A display service 23 of the visualization service 19 reads value curves of measured variables from the local archive memory 21 of the operator station server 14 and generates visualization information from this, for example, for the temporal progression 2 shown in FIGS. 1 to 3.

The operator station client 13 also visually displays a control element 24, which reads out prevailing measured values from the installation image 20 and displays them graphically. The operator can initiate playback of the temporal progression 2 via the control element 24.

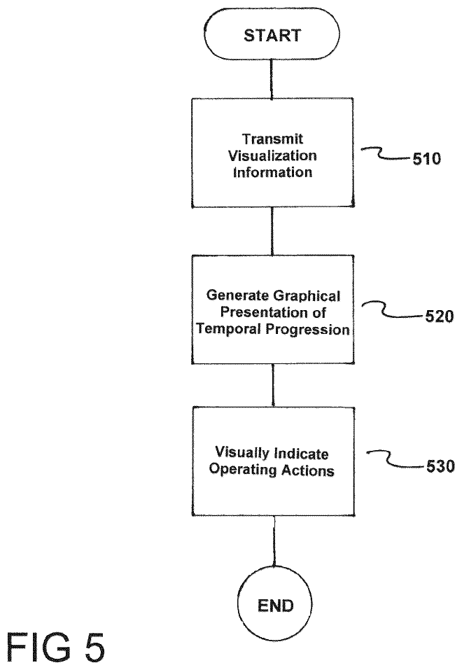

FIG. 5 is a flowchart of the method for operating a control system 12 for a technical installation, in particular a manufacturing or processing installation, which includes at least one operator station server 14 and at least one operator station client 13 operatively coupled to the operator station server 14.

The method comprises a) transmitting visualization information by the operator station server 14 to the operator station client 13, as indicated in step 510.

Next, b) a graphical presentation of a temporal progression 2 of a measured variable of the control system 12 assigned to a technical object of the technical installation within a specific, past time period for an operator of the technical installation is generated via the visualization information and by the operator station client 13, as indicated in step 520.

Next, c) the operating actions being previously implemented by the operator or another operator within the specified, past time period are visually indicated to the operator operating actions by the operator station client 13, as indicated in step 530.

Although the invention has been further illustrated and described in detail with the aid of the preferred exemplary embodiment, the invention is not limited by the disclosed examples and other variations can be derived therefrom by the person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A control system for a technical installation, the method comprising:
at least one operator station server; and
at least one operator station client operatively coupled to the operator station server;
wherein the operator station server is configured to transmit visualization information to the at least one operator station client;
wherein the operator station client is configured to generate, via the visualization information, a graphical presentation for an operator of the technical installation of a temporal progression of a measured variable of the control system assigned to a technical object of the technical installation within a specific, past time period;
wherein the control system is configured to visually indicate to an operator on the operator station client operating actions which have been implemented by the operator or another operator within the specified, past time period.

2. The control system as claimed in claim 1, where the control system is further configured to visually present the indication of the operating actions on the operator station client in response to a request from the operator.

3. The control system as claimed in claim 2, wherein the control system is further configured to provide a selection field visually presented by the operator station client in response to the request from the operator.

4. The control system as claimed in claim 3, wherein the selection field is visually presented at a short visual distance from the temporal progression of the measured variable assigned to the technical object of the technical installation.

5. The control system as claimed in claim 1, wherein the control system is further configured to draw the attention of the operator to the operating actions by marking points in time at which one of the operating actions was implemented respectively in the temporal progression of the measured variable of the control system assigned to the technical object of the technical installation.

6. The control system as claimed in claim 5, wherein the marking is formed as a vertical line.

7. The control system as claimed in claim 6, wherein the vertical line has a coloring which differs from a coloring of the temporal progression of the measured variable of the control system assigned to the technical object of the technical installation.

8. The control system as claimed in claim 7, wherein the coloring is a red coloring.

9. The control system as claimed in claim 1, wherein the control system is further configured to provide the visual presentation of the indication of the operating actions in the form of a message sequence display; and wherein the message sequence display comprises operating messages which each relate to an operating action.

10. The control system as claimed in claim 9, wherein the operating messages each include the operating action performed, a point in time of the operating action and an identity of the operator who performed the operating action.

11. The control system as claimed in claim 1, wherein the control system is further configured to perform the visual presentation of the indication of the operating actions only with respect to the technical object to which the measured variable, to which the graphically presented temporal progression relates, is assigned.

12. The control system as claimed in claim 1, wherein the control system is further configured to perform the graphical presentation of the temporal progression of the measured variable assigned to the technical object of the technical installation based on a selection of an operating message in a message sequence display by the operator; and wherein an operating action of the operating message relates to the technical object assigned to the temporal progression.

13. The control system as claimed in claim 1, wherein the technical installation comprises a manufacturing or processing installation.

14. A method for operating a control system for a technical installation including at least one operator station server and at least one operator station client operatively coupled to the operator station server, the method comprising:
a) transmitting visualization information by the operator station server to the operator station client;
b) generating a graphical presentation of a temporal progression of a measured variable of the control system assigned to a technical object of the technical installation within a specific, past time period for an operator of the technical installation via the visualization information and by the operator station client; and
c) visually indicating to the operator operating actions by the operator station client, the operating actions being previously implemented by the operator or another operator within the specified, past time period.

15. The method as claimed in claim 14, wherein the operator station client performs the visual presentation of the indication of the operating actions in response to a request from the operator; and wherein a selection field presented visually by the operator station client is provided in response to the request from the operator at a small visual distance from the temporal progression of the measured variable assigned to the technical object of the technical installation.

16. The method as claimed in claim 14, wherein the operator station client draws the attention of the operator to the operating actions by marking points in time at which one of the operating actions was implemented respectively in the temporal progression of the measured variable of the control system assigned to the technical object of the technical installation.

17. The method as claimed in claim 15, wherein the operator station client draws the attention of the operator to the operating actions by marking points in time at which one of the operating actions was implemented respectively in the temporal progression of the measured variable of the control system assigned to the technical object of the technical installation.

18. The method as claimed in claim 14, wherein the operator station client provides the visual presentation of the indication of the operating actions as a message sequence display; and wherein the message sequence display comprises operating messages which each relate to an operating action.

19. The method as claimed in claim 15, wherein the operator station client provides the visual presentation of the indication of the operating actions as a message sequence display; and wherein the message sequence display comprises operating messages which each relate to an operating action.

20. The method as claimed in claim 16, wherein the operator station client provides the visual presentation of the indication of the operating actions as a message sequence display; and wherein the message sequence display comprises operating messages which each relate to an operating action.

21. The method according to claim 11, wherein the operator station client performs the graphical presentation of the temporal progression of the measured variable assigned to the technical object of the technical installation based on a selection of an operating message in a message sequence display by the operator; and wherein an operating action of the operating message relates to the technical object assigned to the temporal progression.

22. The method as claimed in claim 11, wherein the technical installation comprises a manufacturing or processing installation.
